(19) United States
(12) Patent Application Publication
(10) Pub. No.: US 2005/0202791 A1
(43) Pub. Date: Sep. 15, 2005

(54) Operating mode extensions in wireless communications networks

(76) Inventor: David J. Krause, Hainesville, IL (US)

Correspondence Address: MOTOROLA INC, 600 NORTH US HIGHWAY 45, ROOM AS437, LIBERTYVILLE, IL, 60048-5343, US

(21) Appl. No.: 10/797,172

(22) Filed: Mar. 10, 2004

(51) Int. Cl. H04Q 7/20

(52) U.S. Cl. 455/127.4

(57) ABSTRACT

A messages and methods for allocating communications network resources including receiving at a first network a message sent (230) from a communications device connected to the first network, assigning the communications device to a second network (240), coordinating and obtaining assignment information from the new network (250, 260), sending an assignment message to the communications device (270), and acquiring the new network (280).

### FIELD OF THE DISCLOSURE

The present disclosure relates generally to communications, and more particularly to messages, for example, origination and page response messages and channel assignment messages, having extended operating mode information, and corresponding methods in communications devices and networks.

### BACKGROUND OF THE DISCLOSURE

Current CDMA-2000 wireless communications standards permit assignment of an AMPS voice channel to a mobile station from a CDMA control channel. Particularly, when a multi-mode CDMA/AMPS mobile station is camped in the CDMA idle state and originates a call or receives a page, the mobile station sends, respectively, an origination message or a page response message to the CDMA network. Both the origination and page response messages include a field called REQUEST_MODE for indicating the ability of the mobile station to accept channel assignments in CDMA or in AMPS or in NAMPS mode. IS-2000.5, Section 3.7.2.3.2.8, Channel Assignment Message, and Section 3.7.2.3.2.21, Extended Channel Assignment Message.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates an exemplary communication network including infrastructure for first and second exemplary wireless communications protocols.

FIG. 2 is an exemplary process flow diagram for providing a channel assignment to a multimode wireless communications device.

FIG. 3 is a schematic diagram portion of an exemplary origination message including information indicating an ability of a multi-mode wireless communications device to operate in another mode.

FIG. 4 is a table with an exemplary encoding scheme for extended request mode information in an origination message.

FIG. 5 is a portion of an exemplary channel assignment message.

FIG. 6 is another portion of an exemplary channel assignment message.

FIG. 7 is another portion of an exemplary channel assignment message.

### DETAILED DESCRIPTION

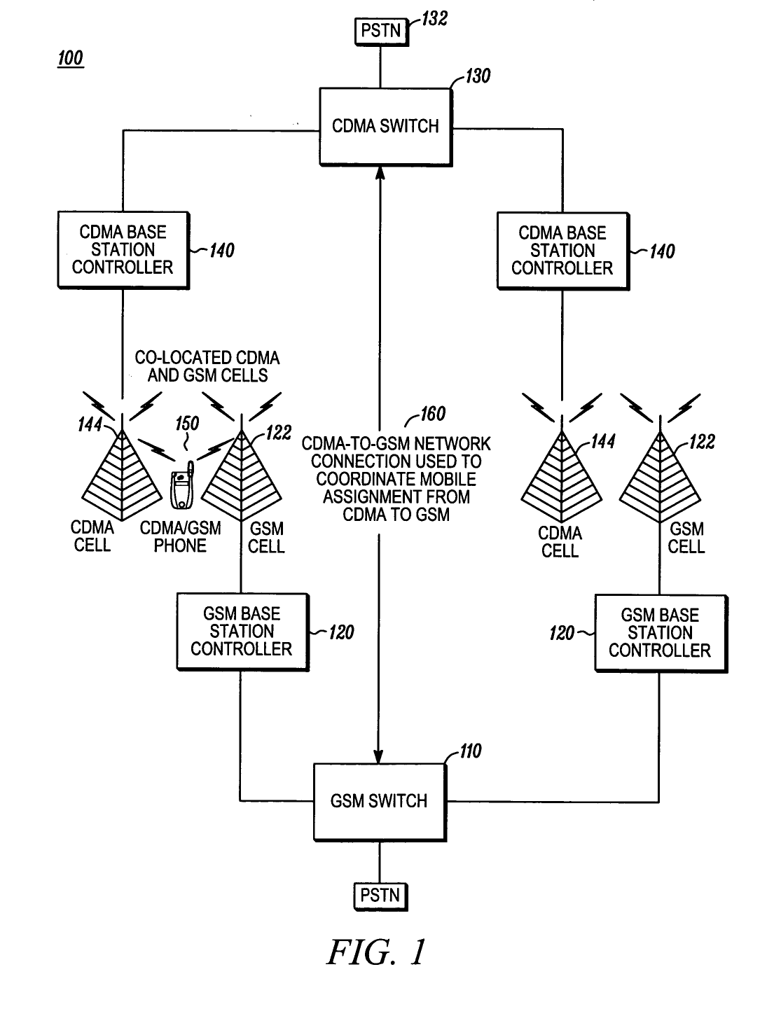

FIG. 1 illustrates an exemplary communication network 100 including infrastructure for a Code Division Multiple Access (CDMA), for example, the CDMA 2000 protocol network, and a Global System for Mobile Communications (GSM) protocol network. The exemplary infrastructure includes a GSM switch 110, for example, a Mobile Switching Center (MSC), communicably interconnecting one or more GSM base station controllers 120 to a Public Switched Telephone network (PSTN) 132. Each base station controller (BSC) 120 is communicably coupled to at least one and typically multiple GSM base transceiver stations 122. The exemplary network also includes a CDMA switch 130 communicably interconnecting one or more CDMA base station controllers 140, each of which is communicably coupled to one or more CDMA base transceiver stations 144, to the PSTN.

The exemplary networks also include other infrastructure that is well known but not illustrated. For example, the exemplary CDMA2000 network may include a packet data serving node (PDSN) and a Home Agent (HA) interconnecting the one or more base station controllers to a packet network like the Internet. The exemplary CDMA network may also include, among other infrastructure, an Interworking Function node interconnecting the CDMA switch 130 to the PDSN. The exemplary GSM network generally includes similar infrastructure.

In FIG. 1, the exemplary CDMA and GSM networks and more particularly the cellular coverage areas of the GSM and CDMA base transceiver stations overlap such that a multimode wireless communications device, for example, CDMA/GSM enabled mobile station (multi-mode phone) 150 in FIG. 1, may communicate on either or both of the CDMA or GSM networks when in areas of overlapping coverage.

In FIG. 1, there is a CDMA to GSM network communication link or connection 160 for coordinating the assignment of mobile stations from one network to the other as discussed further below. In other embodiments one or both of the exemplary GSM and CDMA networks may be other networks operating pursuant to other communications protocols, for example, one of the exemplary networks may be an IS-95 CDMA network, among other networks.

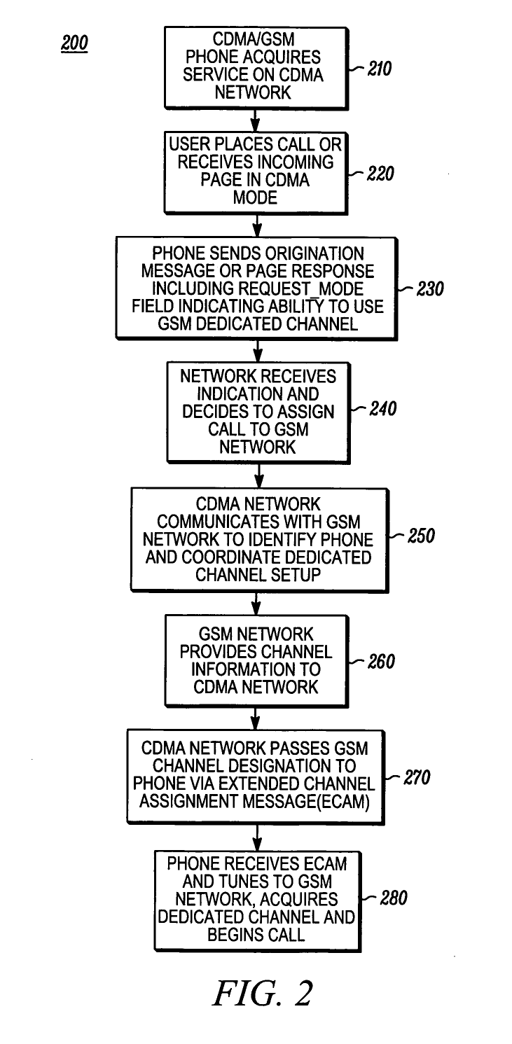

In the process diagram 200 of FIG. 2, at block 210, a multimode wireless communications device connects to a wireless communications network. For example, the CDMA/GSM multi-mode phone 150 of FIG. 1 acquires service on the exemplary CDMA network. In FIG. 2, at block 220, the multimode wireless communications device originates a call or it receives an incoming page while connected to the exemplary CDMA network and while operating in CDMA communications mode. The processes for call origination and page reception are generally specific to the particular protocols pursuant to which the communications device operates.

In FIG. 2, at block 230, the exemplary CDMA/GSM phone generates and sends either an origination message or a page response message, depending on whether the communications device originates a call or responds to a page. In one embodiment, the message indicates that the CDMA/GSM phone is capable of or has the ability to use a GSM dedicated channel, while operating in the CDMA mode. Exemplary message structures are discussed further below.

According to the disclosure, more generally, while the multimode wireless communications device is operating in one communications mode in a first communications network, it generates a message including information indicating an ability of the multi-mode wireless communications device to operate in another different communications mode in a different communications network. In some embodiments, the message indicates that the communications device has an ability to operate in a third communications mode on one of the first or second network. More specific information about the capabilities of the communication device may also be provided. Where the communications device is capable of operating in a GSM network, for example, the message may indicate whether the communications device is capable of operation in single-slot or multi-slot mode. Exemplary message are discussed further below.

In the exemplary CDMA/GSM environment of FIG. 1, while the exemplary CDMA/GSM phone 150 is operating in the CDMA communications mode connected to the CDMA network, the phone 150 generates and send to the network a message including information indicating an ability of the multi-mode wireless communications device to operate in the GSM communications mode. In embodiments where the multimode wireless communications device places or originates a call, the message is an origination message indicating that the multi-mode communications device is capable of operating in a different mode. In embodiments where the multimode communications device receives a page, the alternative operating mode information is included in a page response message. In other embodiments, this information may be included in a message other than origination and page response messages.

In one embodiment, the message includes a first additional mode information field for indicating an ability of a multimode communications device to accept a channel assignment in at least a first additional mode other than a first operating mode. In one embodiment, the first operating mode corresponds to a communications protocol, for example, CDMA 2000, to which the message is native. In some embodiments, the message includes a second additional mode information field for indicating an ability of the multimode communications device operate in a second additional mode other than the first mode and the first additional mode.

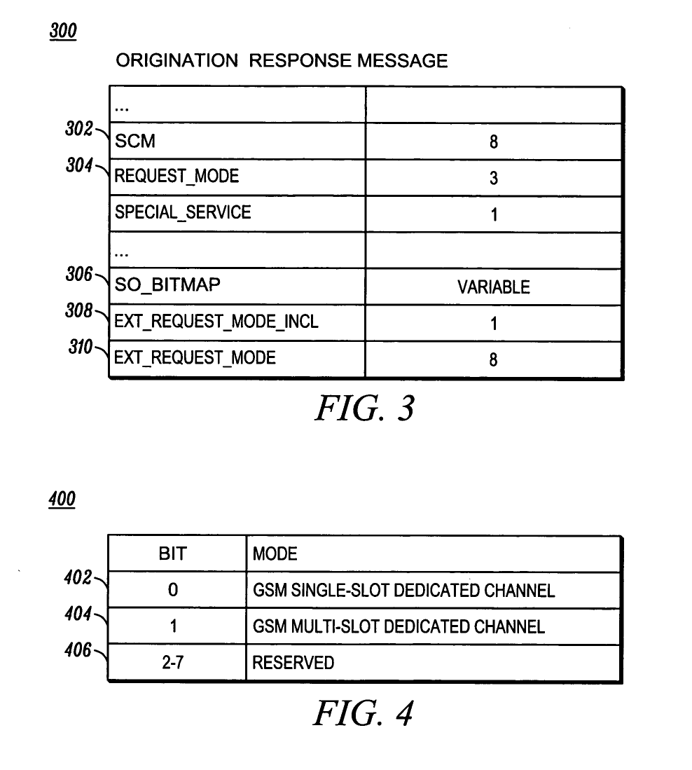

FIG. 3 illustrates schematically a portion of an exemplary origination message 300, for example, a CDMA 2000 origination message. The exemplary message includes a Station Class Mark (SCM) information field 302 having 8 bits assigned thereto, a 3-bit REQUEST_MODE field 304, among other known fields. In existing CDMA 2000 origination messages, the REQUEST_MODE field 304 is for indicating a preference for CDMA or for analog, for example, AMPS or NAMPS, mode operation. Also, in the existing CDMA 2000 origination message structure, the last field in the message is the SO_BITMAP field 306 illustrated in FIG. 3.

In FIG. 3, the exemplary origination message 300 also includes a 1-bit extended request mode included (EXT_REQUEST_MODE_INCL) field 308 for indicating (when set or not set) that the origination message includes extended request mode (EXT_REQUEST_MODE) information. Generally, if included, the EXT_REQUEST_MODE bits are set to indicate alternate or additional modes of operation that the wireless communications device is capable of supporting, for example, at channel assignment.

The exemplary EXT_REQUEST_MODE field 310 includes 8 bits for encoding the additional mode information. The table in FIG. 4 illustrates different exemplary mode information that may be encoded using the exemplary bits in the EXT_REQUEST_MODE field 310 of FIG. 3. In FIG. 4, at 402, the “0” is indicative of GSM Single-Slot Dedicated Channel operating mode, and at 404, the “1” is indicative of GSM Multi-Slot Dedicated Channel operating mode. The remaining bits in the exemplary embodiment may be reserved for future use. In FIG. 4, at 406, the bits 2-7 may be used to indicate an ability of the communications device to communicate using some other mode, for example, voice-over IP, 802.11, UMTS, Bluetooth or some other mode of operation. Alternatively, these bits may be used to indicate some other capability of the communications device. The exemplary EXT_REQUEST_MODE_INCL field and the EXT_REQUEST_MODE field may also be added to a page response message.

In other embodiments, other bit counts and encoding schemes may be employed for indicating alternative operating mode of a communication device in an origination message or in a page response message. Alternative embodiments may include only a single field in the origination or page response message for communicating information about alternative operating modes. In FIG. 3, for example, the alternative operating mode or modes may be indicated by a single field instead of using the EXT_REQUEST_MODE_INCL field 308 and the EXT_REQUEST_MODE field 310.

In FIG. 2, at block 240, the network receives the message from the communications device indicating an ability of the communications device to operate in one or more different communications modes. With information about the capabilities of the communications device, the network may assign a call to a network different than the network on to which the communications device is currently connected. In the exemplary scenario of FIG. 1 where the multi-mode GSM/CDMA phone 150 transmits a message to the CDMA network indicating an ability of the phone 150 to communicate on a GSM network, the CDMA network may elect to assign a call received or originated by the phone to a GSM traffic channel. The exemplary assignment decision may be based on network load and traffic conditions, among other factors.

In FIG. 2, at block 250, the CDMA network or other network to which the communications device is initially connected communicates with the GSM network or other network to which the call could possibly be assigned based on the operating mode capability information that the wireless communications device communicates to the network.

FIG. 1 illustrates the communications link 160 between the exemplary CDMA and GSM networks through which information may be exchanged for determining whether to assign a call of the phone 150 to one network or the other. The communications link 160 also enables the coordination of the assignments from one network to the other. In FIG. 2, at block 260, the GSM network provides channel assignment information to the CDMA network for forwarding to the communications device, which is connected to the CDMA network. The channel assignment information for the exemplary GSM network includes, for example, slot assignment, timing advance, and other information that may be required for the efficient handover of the communications device from the CDMA network to the GSM network.

The network sends an assignment message to the communications device when the communications device originates a call and when the communications device responds to a page. Generally, the assignment message includes assignment information for the any new network to which the communications device will be assigned. In the exemplary embodiment of FIG. 2, at block 270, the CDMA network sends a channel assignment including GSM channel assignment information to the communications device. Generally, the communications device may be assigned directly to a channel on the other network or it may be assigned to an access grant channel to complete set-up on the assigned network. In FIG. 2, at block 280, the communications device receives the channel assignment message having extended assignment information, and the communications device acquires the channel on the newly assigned network. Exemplary channel assignment messages are discussed further below.

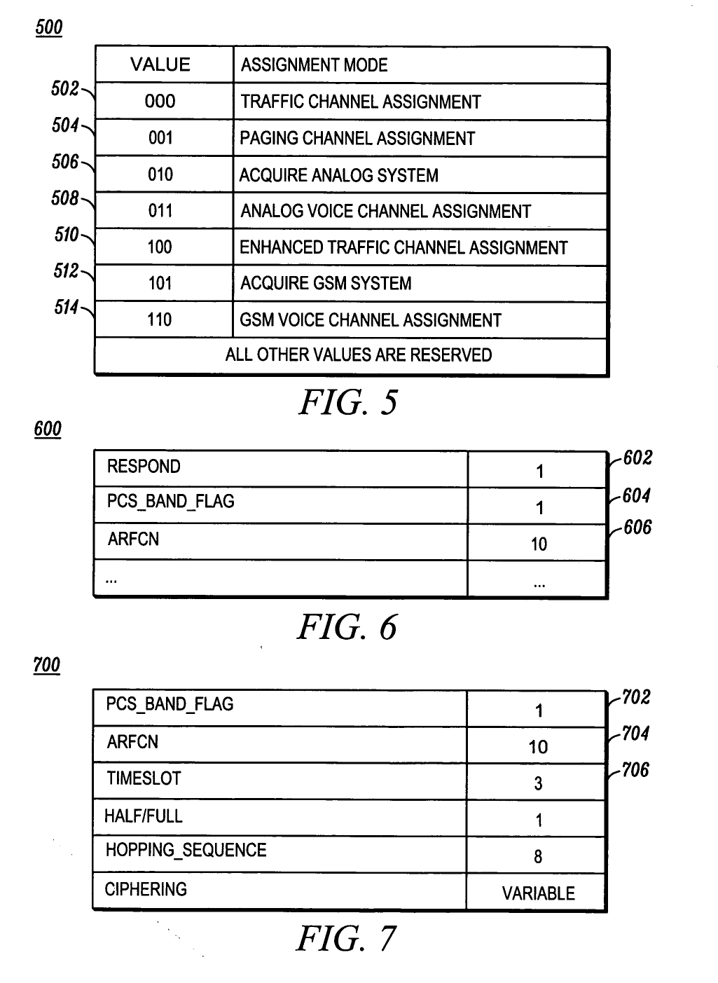

FIG. 5 is an exemplary channel assignment message 500 in which a communications device connected to one network, for example, the CDMA network of FIG. 1, may be assigned to another network, for example, the GSM network of FIG. 1. The exemplary channel assignment message 500 is a CDMA assignment message, which may include on or more known CDMA channel assignment fields, for example, a traffic channel assignment field, 502, a paging channel assignment field 504, an acquire analog system field 506, an analog voice channel assignment field 508, among other known fields. Channel assignment messages native to other communications protocols may include other fields.

In one embodiment, in FIG. 5, the exemplary channel assignment message 500 also includes an enhanced dedicated channel assignment 510 with information facilitating the acquisition of a designated system or channel. In one embodiment, the channel assignment message includes a field for acquiring a designated system. In FIG. 5, at 512, this exemplary field is an acquire GSM system field. In one embodiment, the field 512 indicates that additional information required for the system or channel assignment on the alternative network is included in the message.

In circumstances where the channel assignment message in response to a page response message sent by the communications device, the channel assignment message may indicate whether the communications device should, after transferring to the new network, wait for a new page on the assigned network or re-send the page response to the assigned network without first receiving a page on the assigned network. In FIG. 6, the exemplary channel assignment message may include a respond field 602, which may include one or more bits for indicating whether the communications device should wait for a new page on the new system or network. The exemplary channel assignment fields in FIG. 6 also include GSM channel information (PCS_BAND_FLAG) 604 and channel assignment information (ARFCN) 606.

In some embodiments, the channel assignment message includes a voice channel assignment on another network. The exemplary channel assignment message of FIG. 5 includes a GSM voice assignment field 514. FIG. 7 illustrates an exemplary GSM traffic channel assignment fields that may be incorporated into the channel assignment message, including GSM channel information (PCS_BAND_FLAG) 702 and channel assignment information (ARFCN) 704, time slot information 706, among other known information required for a GSM channel assignment. Other protocols may require other information to effect a channel assignment. In some embodiments, the existence of the GSM voice channel assignment field 514 is used to indicate the existence of additional voice channel assignment information in the message. In other embodiments, the field 514 is not used.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in a multi-mode wireless communications device capable of operating in CDMA and GSM communications modes, the method comprising:
operating the multi-mode wireless communications device in CDMA communications mode;
while operating in CDMA communications mode, generating an origination message including information indicating an ability of the multi-mode wireless communications device to operate in GSM communications mode.

2. The method of claim 1, generating the origination message includes setting a first field indicating that the origination message includes a second field indicating that the multi-mode wireless communications device is able to operate in GSM communications mode.

3. The method of claim 2, generating the origination message includes setting the second field to indicate that the multi-mode wireless communications device is able to operate in GSM communications mode.

4. The method of claim 3, setting the second field includes indicating whether the multi-mode wireless communications device is capable of communicating in at least one of a GSM single-slot mode and a GSM multi-slot mode.

5. The method of claim 1, transmitting the origination message while operating in CDMA communications mode.

6. The method of claim 5, receiving a channel assignment message, in response to sending the origination message, while operating in CDMA communications mode, the channel assignment message including GSM assignment information.

7. The method of claim 6, receiving the channel assignment message includes receiving an instruction to acquire a GSM network before receiving a channel allocation.

8. The method of claim 6, receiving the channel assignment message includes receiving a GSM channel allocation in the channel assignment message.

9. The method of claim 1, indicating that the message includes additional mode information by setting a flag indicating that additional mode information is included in the message.

10. A method in a multi-mode wireless communications device capable of operating in first and second communications modes in corresponding first and second networks, the method comprising:
operating the multi-mode wireless communications device in the first mode communications mode on the first network;
while operating in the first communications mode, generating a message including information indicating an ability of the multi-mode wireless communications device to operate in a second communications mode on the second network,
the message is one of an origination message and a page response message.

11. The method of claim 10, generating the message include setting a flag indicating the presence of the information indicating the ability of the multi-mode wireless communications device to operate in the second communications mode.

12. The method of claim 10,
indicating an ability of the multi-mode wireless communications device to operate in a third communications mode on one of the first and second network.

13. A message for origination or page response by a multimode communications device, the message comprising:
a first additional mode information field of the message for indicating an ability of a multimode communications device to accept a channel assignment in a first additional mode other than a first mode;
a second additional mode information field of the message for indicating an ability of the multimode communications device to accept a channel assignment in a second additional mode other than the first mode and the first additional mode.

14. The message of claim 13,
the first mode is a CDMA communications mode,
the first additional mode is an analog communications mode,
the first additional mode information field for indicating an ability of the multimode communications device to accept a channel assignment in one of the CDMA communications mode and the analog communications mode.

15. The message of claim 13,
the second additional mode is a GSM communications mode,
the second additional mode information field for indicating an ability of the multimode communications device to accept a channel assignment in the GSM communications mode.

16. The message of claim 13,
the first additional information field for indicating a preference of the multimode communications device to accept a channel assignment in one of the first mode and the first additional mode,
the second additional information field for indicating an ability of the multimode communications device to accept a channel assignment in the second additional mode.

17. The origination message of claim 13,
a second additional mode flag field of the message for indicating the presence of information in the second additional mode information field.

18. The origination message of claim 13,
the second additional mode information field of the message for indicating an ability of the multimode communications device to accept a channel assignment in a second additional mode pursuant to at least one of a GSM communications protocol, an 802.11 communications protocol, a UMTS communications protocol, and voice over IP communications protocol.

19. A method in a CDMA communications network, the method comprising:
generating a channel assignment message;
providing GSM channel assignment information in the channel assignment message.

20. The method of claim 19, providing GSM channel assignment information in the channel assignment message includes providing information indicating that additional GSM channel assignment information is provided in the channel assignment message.

21. The method of claim 19, providing GSM channel assignment information in the channel assignment message includes providing assignment information for one of a GSM access grant channel or a GSM dedicated channel.

22. The method of claim 19, providing GSM channel assignment information in the channel assignment message includes providing information to re-send one of an origination message or page response message on a GSM Channel.

23. The method of claim 19,
transmitting the channel assignment message to a wireless communications device connected to the CDMA communications network,
providing the GSM channel assignment information in the channel assignment message includes providing a direct channel assignment.

24. The method of claim 19,
transmitting the channel assignment message to a wireless communications device connected to the CDMA communications network,
providing the GSM channel assignment information in the channel assignment message includes providing an access grant channel for the communications device to complete set up on the GSM network.

25. A method for network resource allocation in a first communications network, the method comprising:
receiving a message from a multimode mobile station;
generating a channel assignment message for the multimode mobile station operating in a first communications on the first network in response to the message;
assigning the multimode mobile station to a second network in the channel assignment message;
transmitting the channel assignment message to the multimode mobile station.

26. The method of claim 25, assigning the multimode mobile station to a second network in the channel assignment message includes providing a direct channel assignment in the channel assignment message.

27. The method of claim 25,
assigning the multimode mobile station to a second network in the channel assignment message includes providing an access grant channel for the communications device to complete set up on the second network.

28. A method in a multimode communications device, the method comprising:
receiving a channel assignment message while operating in a first mode pursuant to a first communications protocol,
the channel assignment message including channel assignment information for a mode of operation pursuant to a second communications protocol;
transitioning to one of an access grant channel or a dedicated channel based on the channel assignment information for the different mode of operation.

29. The method of claim 28, operating pursuant to a second communications protocol pursuant to the different mode of operation;

30. The method of claim 28, the first mode is CDMA mode, the second mode is GSM mode,

31. A channel assignment message native to a first communications protocol for transmission to a multimode communications device operable in a mode pursuant to the first communications protocol and operable in at least one other mode pursuant to a second communications protocol, comprising:
channel assignment information of the channel assignment message including assignment information for one of an access grant channel of the second communications protocol or a dedicated channel of the second communications protocol.

32. The channel assignment message of claim 31 is native to a CDMA communications protocol, the channel assignment information of the channel assignment message is for a GSM communications protocol.
